(19) United States
(12) Patent Application Publication
(10) Pub. No.: US 2008/0117339 A1
(43) Pub. Date: May 22, 2008

(54) REMOTE CONTROL BASED CONTENT CONTROL

(75) Inventor: Richard Kirsche, Ringoes, NJ (US)

Correspondence Address: BROOKS KUSHMAN P.C., 1000 TOWN CENTER, TWENTY-SECOND FLOOR, SOUTHFIELD, MI, 48075, US

(73) Assignee: COMCAST CABLE HOLDINGS, LLC, Philadelphia, PA (US)

(21) Appl. No.: 11/561,535

(22) Filed: Nov. 20, 2006

(51) Int. Cl. H04N 5/44

(52) U.S. Cl. 348/734; 348/E05.096

(57) ABSTRACT

Remote control based content control that allows one or more remote control users to control content or other materials being shown or displayed through a television or other display. The control may optionally include split screen display control and/or remote control/user based content control.

### BACKGROUND OF THE INVENTION

1. Field of the Invention

The present invention relates to remote control based content control, which may optionally include controlling content interfaced through different portions of a common display, i.e., to provide split screen control.

2. Background Art

A television and other display type devices may be used to display or otherwise interface users with content, such as but not limited to content associated with television programs/channels/movies, gaming, etc. Typically, the whole display is used to display the content with optional graphical overlays. A user may change or otherwise content the displayed content with a remote control or similar feature. Similarly, however, a single remote control is typically used to control the content.

Attempts have been made, such as with picture-in-picture, to divide up the content showing in the display such that different portions of the display may show different television channels, etc. These approaches, however, are limited to controlling the content in each display portion with a single remote control.

### BRIEF DESCRIPTION OF THE DRAWINGS

The present invention is pointed out with particularity in the appended claims. However, other features of the present invention will become more apparent and the present invention will be best understood by referring to the following detailed description in conjunction with the accompany drawings in which:

FIG. 1 illustrates a system for split screen control in accordance with one non-limiting aspect of the present invention; and

FIG. 2 illustrates a flowchart associated with a method of providing split screen control in accordance with one non-limiting aspect of the present invention.

### DETAILED DESCRIPTION OF THE PREFERRED EMBODIMENT(S)

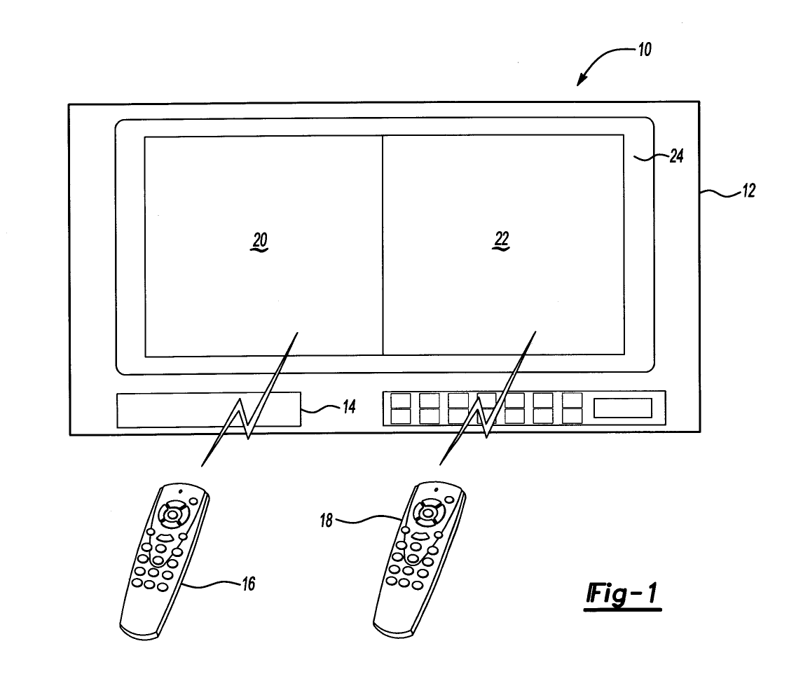

FIG. 1 illustrates a system 10 for split screen control in accordance with one non-limiting aspect of the present invention. The system 10 generally relates to a television 12 having a settop box (STB) 14 or other control feature and at least two remote controls 16-18 for controlling at least two different portions 20-22 of a television screen 24. The control feature may be configured to differentiate signals from each of the remote controls such that each remote control 16-18 may be used to control content associated with a corresponding portion 20-22 of the display 24.

The present invention is predominately described with respect to a cable television environment associated with a cable television media service provider. The present invention, however, is not so limited and fully contemplates non-cable television environments, such as but not limited to those associated with satellite television, high-speed data, telecommunications, cellular communications, and the like.

A media provider may be configured to support and/or facilitate the use of any number of television and non-television services and applications, such as, but not limited to, linear and non-linear television programming/signaling (cable, satellite, broadcast, etc.), Video on Demand (VOD), interactive television (iTV), interactive and non-interactive gaming, pay-per-view (PPV), digital video recording (local and remote), and others.

The content and services associated with the media provider may be delivered to the television or other display device 24 through any number of features and devices associated with interfacing subscriber locations with each other and the media provider or otherwise supporting communications associated with services of the media provider. A network (not shown) may include terrestrial and extraterrestrial components and infrastructures, including cable lines, telephone lines, and/or satellite or other wireless architectures to support such communication.

The television 24 is shown for exemplary purposes, however, the present invention is not so limited and fully contemplates facilitating split screen control with any type of displaying media device, whether or not the device actual displays the content or facilitates displaying the content, such as but not limited to a settop box (STB), digital video recorder (DVR), personal computer (PC), outlet digital adapter (ODA), media terminal adapter (MTA), cable modem (CM), personal digital assistant (PDA), computer, mobile device (phone, computer, etc.), personal media device, and any other item having capabilities to supporting access to any number of the services.

The media device may be configured to descramble and support and/or facilitate the use of any number of television and non-television related signals, such as but not limited to Hyper Text Transfer Protocol (HTTP), Dynamic Host Configuration Protocol (DHCP), Syslog, Simple Network Management Protocol (SNMP), Trivial File Transfer Protocol (TFTP), Data Over Cable Service Interface Specification (DOCSIS), Domain Name Server (DNS) applications, DOCSIS Settop Gateway (DSG), out-of-band (OOB) messaging, and others.

In operation, a software application, program, application program interface, or other logically functioning element may be download or otherwise configured to operation with (i.e., STB 14) or on the display device 24 in order to execute or facilitate executing the operations associated with providing the split screen control of the present invention or remote control 16-18 based control of content available for interfacing through the device 24.

The application may interface with and/or operate in conjunction with an operating platform of the STB 14 or other device associated with the display device 24 so as to facilitate separately controlling user interaction with content being shown, displayed, or otherwise interfaced within the different portions of the display. The STB 14, display device 24, or other feature operating with the display may be programmed, instructed, configured, or otherwise adapted or enhanced in order to provide the split screen and/or content control of the present invention, include being configured with or adapted to include any type of hardware or software elements associated with providing the same.

This may include provisioning the element to permit separately displaying user interfaces, electronic programming guides (EPGs), web portals, menus, advertisements, recommendations, audio, and any other elements commonly associated with a single displays such that those features and elements may be separately displayed and controlled within different portions 20-22 a single display area 24.

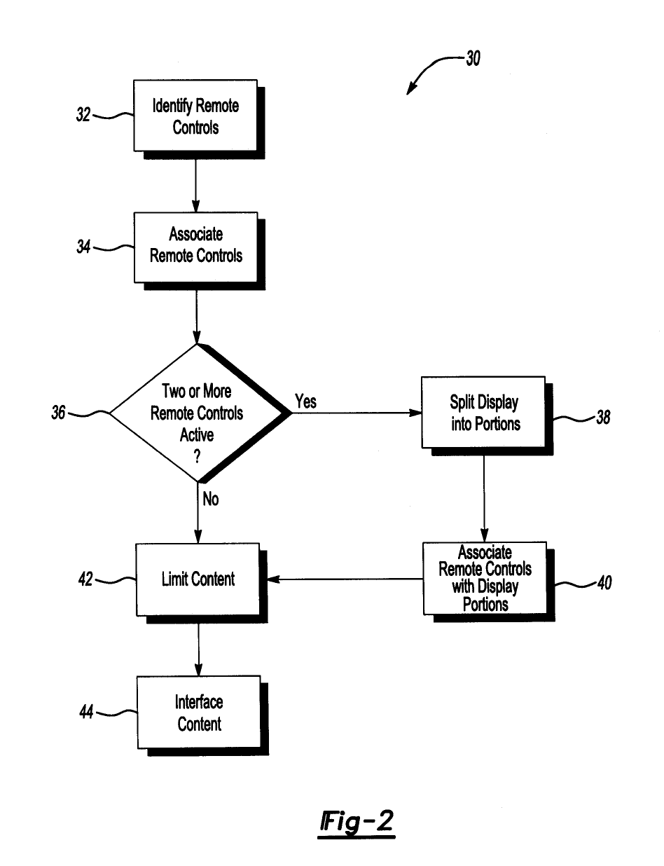

FIG. 2 illustrates a flowchart 30 associated with a method of providing split screen and/or content control in accordance with one non-limiting aspect of the present invention. The flowchart 30 may be associated with the above-described logical entity or with any other feature suitable to facilitating the control contemplated by the present invention. The method may be used to control any type of content suitable for use with a display, including but not limited to audio, data, video and/or gaming related content.

Block 32 relates to identifying remote controls that are to be used in conjunction with controlling the content. The remote controls may be identified by the application operating with the display to provide the control of the present invention as a function of signals from the remote control, user interaction with the application, display, remote control, and/or through any other procedure suitable to separately identifying signals from each of the remote controls in a manner sufficient to permit control in accordance with the present invention.

Block 34 relates to associating the remote controls with users and/or sets of content. The identity of the user may be fixed with the respective remote control and/or the identity may be determined through user interaction with the remote control and/or the application operating with the display to provide the split screen control of the present invention. For example, certain remote controls may be associated with particular users, such as but not limited through user interfaces and other means for inputting user characteristics, so that preferences and other features associated with the one or more associated users may be used when interfacing content with the users. Likewise, content sets may be selected and/or otherwise associated with the users so as to restrict/facilitate access to particular types of content.

Block 36 relates assessing an activity status of one or more remote controls, i.e., whether the remote controls are active or inactive. For example, a number of remote controls may be associated with different users—such as but not limited to environments when users have personal remote controls and/or personal media devices of the user may be used as remote controls—wherein one or more of the remote controls may not be in use or otherwise needed to control content display. Remote controls deemed not to be in use or in proximity to the display may be characterized as inactive and remote controls desired to be use or in proximity to the display may be characterized as being active.

Block 38 relates to splitting the display as a function of the number of remote controls. The display portions may be characterized as portions of the display in which different sets or streams of content may be shown, displayed, or otherwise interfaced through the display. The number of display portions may optionally correspond with the number of remote controls identified in Block 32 and/or the number of remote controls identified to be active in Block 36 so that at least one display portion may be associated with each remote control. More than one display portion may be associated with one or more of the remote controls to permit one or more of the remote controls to control multiple display portions (picture-in-picture) and the shapes, forms, areas, and other parameters of the display portions may be specified and/or varied with respect to each other or otherwise controlled.

Block 40 relates to associating the remote controls with portions of the split display. This may include combining information determined in the preceding blocks, i.e., with respect to the number of remote controls and the number of display portions to be controlled with each remote control, so as to allocate portions of the display for control by each of the remote controls. In this manner, each remote control may be used to control content showing in its corresponding display portion, thereby providing split screen control in accordance with the present invention.

Block 42 may relate to limiting content available through each of the control portions as a function of the corresponding remote control and/or the identified user. For example, certain remote controls, such as but limited to adult and child remote controls, may be automatically limited to display certain types of content and accessing certain types of content, irrespective of the actual user of the same. This may be helpful in providing parental control. Likewise, the identity of the user may be used to limit access to control associated with the user, such as but not limited to providing parental control capabilities, content availability (may be subscription based), etc.

Block 42 may include limiting content according to any number of other parameters associated with the remote controls and/or the identity of the user thereof. This may include limiting based on rating (parental control), preferences, habits, DVR allocation, etc.; recommending content as a function of the corresponding remote control and/or the identified user; and/or customizing or otherwise adapting user interfaces in the display portions according to any number of other parameters associated with the remote controls and/or the identity of the user thereof, including but not limited customizing menus, navigation tools, homepages, channel selections, favorite guides, and other options associated with user interfaces and controls associated with accessing, selecting, organizing, or otherwise managing the content interfaced through the display.

If Block 36 determines only one of the remote controls to be active, Block 42 may be directly reached, i.e., without executing the steps associated with split screen view, such that the active remote control may be used to interface content within the entire display, and not just a portion thereof. Similar content limitations may be implemented based on the identity of the active remote control and/or the identity of the user thereof.

Block 42 may optionally include facilitating audio playback for content having audio. This may include simultaneously controlling outputting of the audio so that audio from each display portion is heard. The audio control may also include preventing audio from one or more of the display portions, such as but not limited to as a function of the remote control or user identity (one user may be dominate relative to another user, etc.) and/or as a function of content (sporting events, for example, may be controlled to be silent relative television viewing). The audio from one or more of the display portions may be transmitted to personal audio units (headsets, etc.), either through wireline or wireless communications, so as to permit one or more of the users to listen to audio independently or other audio associated with the other displayed content.

As noted above, one non-limiting aspect of the present invention may relate to allowing different remote controller users to control content showing on a split television screen. A portion of the screen may be allocated to one user and the other portion is allocated to the other user with each portion of the screen being controlled with a different remote.

One non-limiting aspect of the present invention generally may relate to controlling content displayed on a television or similar display. The invention optionally relies upon the use of separate remote controls to facilitate simultaneously controlling content showing on the television. The remote controls may interact with a STB or other console associated with showing the content.

User identities may be associated with the remote controls. The identities may be used to filter or pre-select menu options, advertising, parental control, and any number of other features. Other features may include audio control, gaming, Bluetooth, etc

Associating user identities with the remote control may be helpful especially with parental control. For example, remote controls may be associated with children such that use of those remote controls results in automatically limiting the available content. There are any number of other identity based controls that could be similarly introduced.

The present invention solves issues associated with multiple users desiring to watch different channels on the same television. As televisions become larger, it becomes more feasible to split the viewing area such that different portions may be allocated to different users.

As required, detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of displaying television programs on a television, the method comprising:
associating a first remote control with a first portion of a display associated with the television;
associating a second remote control with a second portion of the display; and
displaying programs controlled with the first remote control on the first portion of the display and simultaneously displaying programs controlled with the second remote control on the second portion of the display such that each remote control simultaneously and actively controls programs showing on corresponding portions of the television.

2. The method of claim 1 further comprising associating a user with one of the remote controls and displaying the programs as a function of the associated user.

3. The method of claim 1 wherein displaying the programs includes facilitating program selection with user interfaces associated with each display portion such that each user interface is separately controlled with the remote control associated with the corresponding display portion.

4. The method of claim 3 further comprising coordinating options within the user interfaces as a function of the remote controls associated therewith.

5. The method of claim 1 further comprising simultaneously playing audio associated with each program showing in the display portions.

6. The method of claim 5 further comprising playing the audio through separate user devices such that each user associated with the remote controls hears the audio corresponding with the portion of the display associated with the remote control of that user and without hearing the audio from the other portion of the display.

7. The method of claim 1 further comprising limiting content available for showing in the display portions as a function of the remote control associated therewith.

8. The method of claim 7 further comprising associating a user with one of the remote controls and limiting the content as a function of the user.

9. The method of claim 1 further comprising recommending content available for showing in the display portions as a function of the remote control associated therewith.

10. The method of claim 9 further comprising associating a user with one of the remote controls and recommending the content as a function of the user.

11. The method of claim 1 further comprising coordinating advertisements showing in the display portions as a function of the remote control associated therewith.

12. The method of claim 11 further comprising associating a user with one of the remote controls and coordinating the advertisements as a function of the user.

13. A method of controlling content associated with multiple users of a common display, the common display used by the multiple users for interfacing with the content, the method comprising:
associating a first remote control with a first portion of the display and associating a second remote control with a second portion of the display; and
controlling content associated with the first display portion as a function of signals associated with the first remote control and simultaneously controlling content associated with the second display portion as a function of signals associated with the second remote control such that each remote control simultaneously and actively interfaces users of the remote controls with content associated with different portions of the television.

14. The method of claim 13 wherein the content in at least one of the display portions relates to gaming such that the remote control associated therewith emits gaming signals for controlling user interfacing with a gaming application.

15. The method of claim 12 further comprising coordinating advertisements, recommending content or limiting content available for showing in the display portions as a function of the remote control associated therewith.

16. A method of interfacing content on a display, the method comprising:
associating a first remote control with a first set of content;
associating a second remote control with a second set of content;
determining an activity state of at least one of the first or second remote controls; and
limiting content available for display to at least one of the first or second sets of content as a function of the activity state of at least one of the first or second remote controls.

17. The method of claim 16 further comprising limiting content available for display to the first set of content if only the first remote control is active.

18. The method of claim 16 further comprising limiting the content available for display to the second set of content if only the second remote control is active.

19. The method of claim 16 further comprising limiting the content available for display to both of the first and second sets of content if both of the first and second remote controls are active.

20. The method of claim 19 further comprising providing split display interfacing of the first and second sets of content if both of the first and second remote controls are active.
